(19) United States
(12) Patent Application Publication
(10) Pub. No.: US 2014/0236915 A1
(43) Pub. Date: Aug. 21, 2014

(54) SYSTEM AND METHOD FOR RETRIEVING PHYSICIAN INFORMATION

(71) Applicant: BAYCARE HEALTH SYSTEM, INC., Clearwater, FL (US)

(72) Inventor: Stewart Schaffer, Clearwater, FL (US)

(73) Assignee: BAYCARE HEALTH SYSTEM, INC., Clearwater, FL (US)

(21) Appl. No.: 13/773,556

(22) Filed: Feb. 21, 2013

(51) Int. Cl. G06F 17/30

(52) U.S. Cl. CPC G06F 17/30864
USPC 707/706

(57) ABSTRACT

An information retrieval system is provided with an interface, search engine, and database. The interface is operable on a computerized device with a processor and memory. The search engine may analyze search terms to create a filter and select a search mode. The database may include a database engine and data. The database engine may perform the filtered search of a database using the search terms created by the search engine and return results that are ranked. The search engine may sort the results that are ranked to be displayed to the user. A method is provided for retrieving information using the information retrieval system. The method includes defining a search parameter, analyzing the search parameter, filtering the parameters, searching a database using a database engine, ranking the results, and sorting the results that are ranked to be displayed to a user.

### FIELD OF THE INVENTION

The invention relates to information retrieval. More particularly, the invention relates to a system and method for searching and retrieving information relating to a physician.

### BACKGROUND

A vast wealth of information is available to the general public. Much of this information is stored electronically, and accessible to the public via the internet. Often, search tools are required to locate specific information from a connected network. As more information is transitioned into electronic form, and the quantity of information continues to grow, standard searching tools increasingly return unrelated or undesired results. This is especially true for members of the public searching for a medical practitioner.

Performing a standard search for a suitable medical practitioner may often return an overwhelming number of results. Some results may not relate to medical practitioners. Other results may relate to practitioners that do not practice in a desired field or location. The imprecision of current search procedures cause wasted time and missed client-physician relationships.

What is needed is a system to combine multiple dimensions of search terms, data types, existing and historical records, and other data to dynamically create search results. What is also needed is a system to compare this information to return search results with a high degree of accuracy. What is further needed is an accessible interface for users to define search parameters and receive search results.

### SUMMARY

An information retrieval system is provided by the present invention with an interface, search engine, and database. The interface is operable on a computerized device with a processor and memory. The search engine may analyze search terms to create a filter and select a search mode. The database may include a database engine and data. The database engine may perform a filtered search of the database using the search terms created by the search engine and return results that are ranked. The search engine may sort the results that are ranked to be displayed to the user.

A method is provided by the present invention for retrieving information using the information retrieval system. The method includes defining a search parameter, analyzing the search parameter, searching a database using a database engine, ranking the results, and sorting the results that are ranked to be displayed to a user.

According to embodiments of the present invention, a system and method for retrieving physician information are described that may combine multiple dimensions of search terms, data types, existing and historical records, and other data to dynamically create search results. The system and method of the present invention are also provided to compare this information to return search results with a high degree of accuracy. Furthermore, the system and method of the present invention provides an accessible interface for users to define search parameters and receive search results.

In one aspect, an information retrieval system is provided with an interface, search engine, and database engine. The interface is operable on a computerized device with a processor and memory to be manipulated by a user to receive a search term. The search engine may analyze the search terms to create a filter and select a search mode. The database engine may perform a filtered search of a database using the search terms created by the search engine and return results that are ranked. The search engine may sort the results that are ranked to be displayed to the user.

In another aspect, the interface may be further manipulated by the user to select a category of results. Ranking of the results may be affected by the category of results selected.

In another aspect, the category of results may be selected from a group consisting of physicians, procedure or diagnosis, symptoms, location, facilities, and specialties.

In another aspect, the results may be ranked by the database engine prior to being returned to the search engine.

In another aspect, the results may be displayed to the user via the interface.

In another aspect, the results may be displayed to the user approximately as the results are determined. In one embodiment, the results may be displayed to the user in approximately real time.

In another aspect, the interface may be presented to the user over a network. In another aspect, the interface may be presented to the user via a website.

A method aspect is provided for retrieving information using an information retrieval system with a processor and memory. The method may include defining a search parameter using an interface. The method may also include analyzing the search parameter using a search engine to create a filter and select a search mode. Additionally, the method may include searching a database using a database engine with the search parameter filtered by the search engine to return results. The method may also include ranking the results. The method may include sorting the results that are ranked to be displayed to a user via the interface.

In another aspect of the method, the search parameter may include a search term and a category of results. In this aspect, ranking the results may be performed respective to the category of results selected.

In another aspect of the method, the category of results may be selected from a group consisting of physicians, procedure or diagnosis, symptoms, location, facilities, and specialties.

In another aspect of the method, ranking the results may be performed using the database engine.

In another aspect of the method, sorting the results may be performed using the search engine.

In another aspect of the method, the interface may be presented to the user over a network. In another aspect of the method, the interface may be presented to the user via a website.

In another aspect of the method, sorting the results may further include displaying the results to the user approximately as the results are determined.

A method aspect is provided for retrieving information using an information retrieval system with a processor and memory. The method may include defining a search term using an interface accessible over a network. The method may also include analyzing the search term using a search engine to create a filter and select a search mode. Additionally, the method may include searching a database using a database engine with the search term filtered by the search engine to return results. The method may also include ranking the results using the database engine. The method may include sorting the results that are ranked using the search engine to be displayed to a user via the interface.

In another aspect of the method, defining the search term may further include selecting a category of results. Additionally, ranking the results using the database engine may further include ranking the results respective to the category of results selected.

In another aspect of the method, the category of results may be selected from a group consisting of physicians, procedure or diagnosis, symptoms, location, facilities, and specialties.

In another aspect of the method, sorting the results using the search engine may further include displaying the results to the user approximately as the results are determined.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a block diagram illustrating an overview of the system, according to an embodiment of the present invention.

FIG. 2 is a block diagram illustrating a computerized device usable by the system, according to an embodiment of the present invention.

FIG. 3 is a block diagram illustrating data flow of the system, according to an embodiment of the present invention.

FIG. 4 is a flowchart illustrating general operation of the method, according to an embodiment of the present invention.

FIG. 5 is a flowchart illustrating defining search parameters as illustrated by FIG. 5 in greater detail, according to an embodiment of the present invention.

FIG. 6 is a flowchart illustrating analyzing search parameters as illustrated by

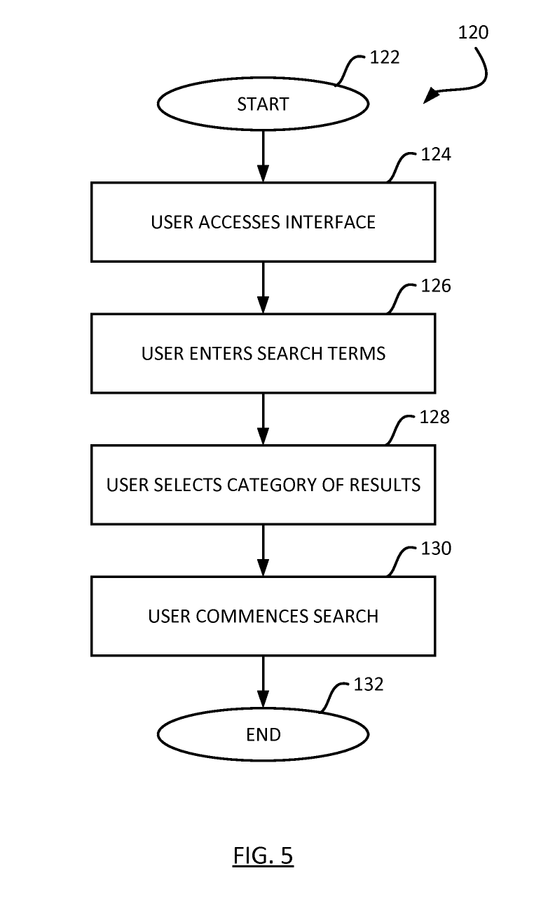

FIG. 5 in greater detail, according to an embodiment of the present invention.

FIG. 7 is a flowchart illustrating searching a database as illustrated by FIG. 5 in greater detail, according to an embodiment of the present invention.

FIG. 8 is a flowchart illustrating returning results as illustrated by FIG. 5 in greater detail, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings. In the following description, a system and method for retrieving physician information will be discussed. Those of skill in the art will appreciate alternative labeling of the system and method for retrieving physician information as a search system, system, method, the invention, or other similar names. Skilled readers should not view the inclusion of any alternative labels as limiting in any way.

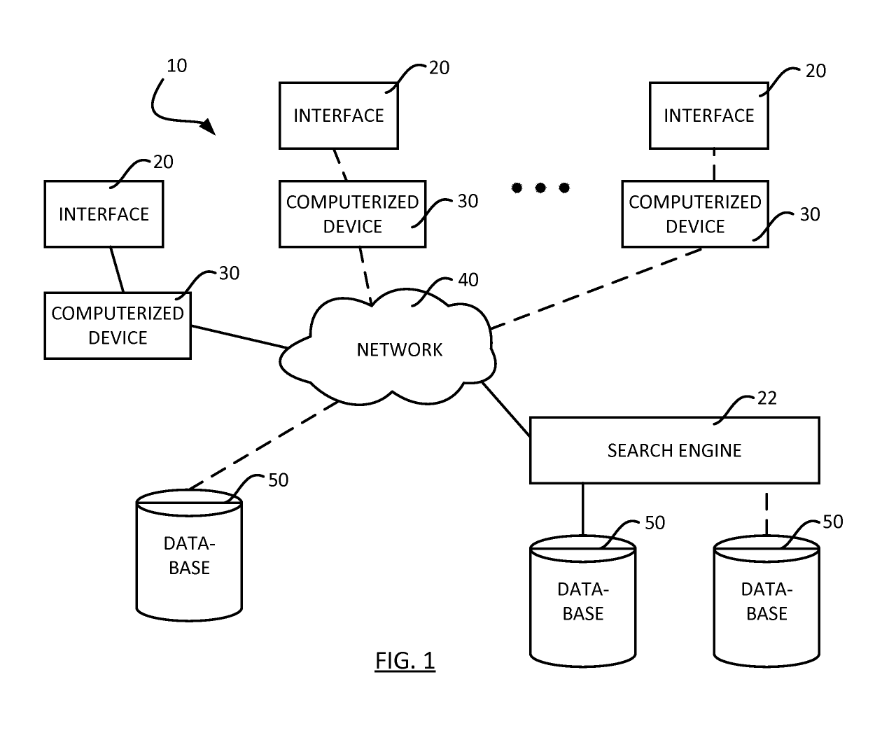

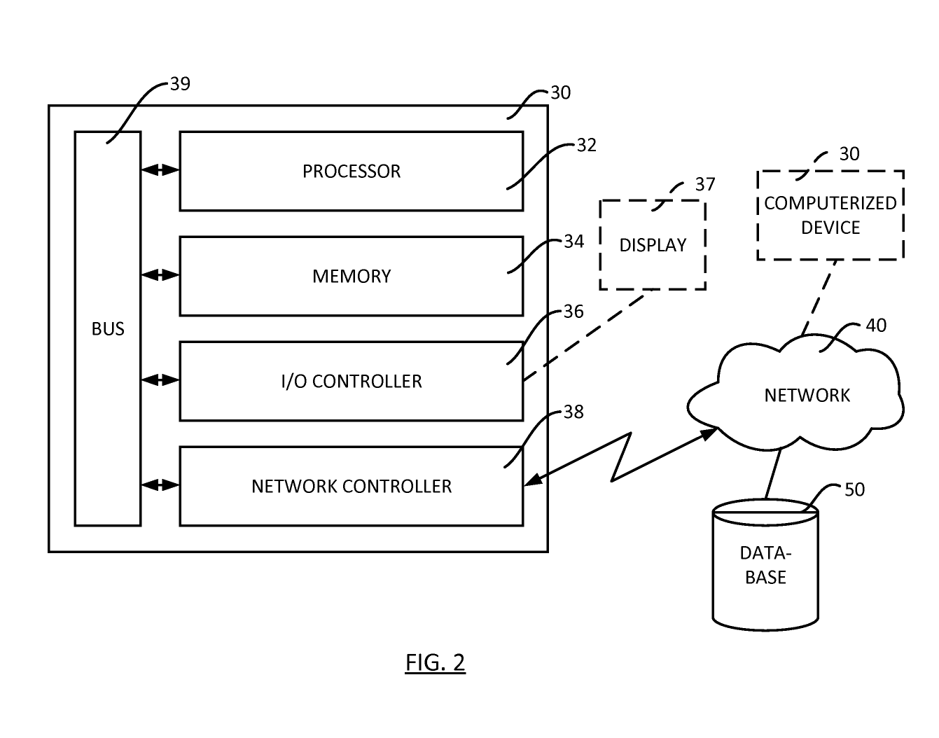

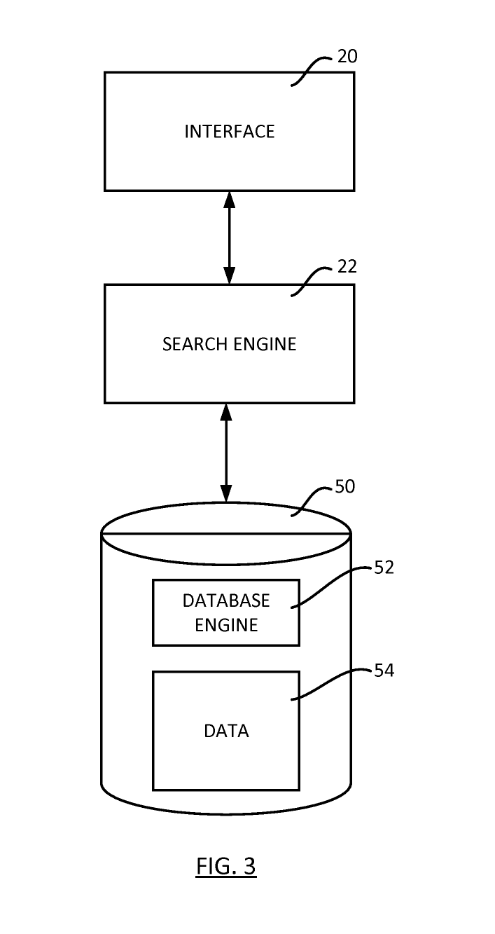

Referring now to FIG. 1, along with FIG. 3, an overview of the system 10 will now be discussed. The system 10 may include an interface 20, a computerized device 30, a network 40, a search engine 22, and a database 50. A user may interact with the system 10 via the interface 20, which may be accessed using the computerized device 30. The interface 20 and computerized device 30 will be discussed in greater detail below. The interface 20 may access and/or display data 54 communicated over a network 40. Transmission paths of data 54 may be represented by the connecting lines between the elements of FIG. 1. Additional discussion relating to the data 54 can be found below and along with FIG. 3. The interface 20 may provide access another computerized device 30, such as a server, on which the search engine 22 may be operated. The search engine 22 may be operatively connected to a database 50, which may include data to be searched.

As illustrated in FIG. 1, multiple interfaces 20 may be accessed and manipulated by multiple users simultaneously. Various instances of the interface 20 may be accessed on multiple computerized devices 30. These computerized devices 30 may include, without limitation, personal computers, tablets, phones, smartphones, PDAs, or other interactive electronic devices. Additionally, the search engine 22 may be optionally connected to multiple databases 50. The search engine 22 may connect to the databases 50 physically and/or over a network 40. Operation of the search engine 22 will be discussed below in greater detail.

A user may access the interface 20 using a computerized device 30. An illustrative computerized device 30 that may connect with the system 10 and other computerized devices 30 is provided by the block diagram of FIG. 2, along with FIG. 3. Skilled artisans will appreciate that the embodiment illustrated by FIG. 2 has been provided in the interest of clarity, and is not intended to limit the present invention in any way. The system 10 may include, generally, a computerized device 30, a database 50, a network 40, and optionally one or more additionally connected computerized device 30.

An example of a computerized device 30 will now be discussed in greater detail. The computerized device 30 may include a processor 32, memory 34, input/output (I/O) controller 36, and network controller 38. Skilled artisans will appreciate additional embodiments of a computerized device 30 that may omit one or more of the aforementioned components or include additional components without limitation. The processor 32 may receive and analyze data. The memory 34 may store data, which may be used by the processor 32 to perform the analysis. The memory 34 may also receive data indicative of results from the analysis of data by the processor 32.

The memory 34 may include volatile memory modules, such as random access memory (RAM), or non-volatile memory modules, such as flash based memory. Skilled artisans will appreciate the memory 34 to additionally include storage devices, such as, for example, mechanical hard drives, solid state data, and removable storage devices.

The computerized device 30 may also include a network controller 38. The network controller 38 may receive data from other components of the computerized device 30 to be communicated with other computerized devices 30 and/or database 50 via a network 40. More specifically, without limitation, the network controller 38 may communicate and relay information from one or more components of the computerized device 30, or other devices and/or components connected to the computerized device 30, to additional connected devices. Connected devices are intended to include data servers, additional computerized device 30, mobile computing devices, smart phones, tablet computers, and other electronic devices that may communicate digitally with another device. In one example, the computerized device 30 may be used as a server to analyze and communicate data between connected devices.

The computer may also include an I/O controller 36. The I/O controller 36 may be used to transmit data between the computerized device 30 and peripheral devices. Examples of peripheral devices may include, but should not be limited to, a display 37, external storage device, human interface device, printer, sound controller, or other components that would be apparent to a person of skill in the art. Additionally, one or more of the components of the computerized device 30 may be communicatively connected to the other components via the I/O controller 36.

The components of the computerized device 30 may interact with one another via a bus 39. Those of skill in the art will appreciate various forms of a bus 39 that may be used to transmit data 54 between one or more components of an electronic device, which are intended to be included within the scope of this disclosure. Transmission paths of data 54 may be represented by the connecting lines between the elements of FIG. 2. Additional discussion relating to the data 54 can be found below and along with FIG. 3.

The computerized device 30 may communicate with one or more connected devices via a network 40. The computerized device 30 may communicate over the network 40 by using its network controller 38. More specifically, the network controller 38 of the computerized device 30 may communicate with the network controllers 38 of the connected devices. The network 40 may be, for example, the internet. However, skilled artisans will appreciate additional networks to be included within the scope of this disclosure, such as intranets, local area networks, wide area networks, peer-to-peer networks, and various other network formats. Additionally, the computerized device 30 and/or connected devices may communicate over the network 40 via a wired, wireless, or other connection, without limitation.

A database 50 may be communicatively connected to the computerized device 30 and/or the network 40. In one embodiment, a computerized device 30 may be directly connected to the database 50. The direct connection may be a physical connection or a virtualized physical connection, such as one made via a virtual private network, without limitation. Alternatively, the database 50 may be communicatively connected to the computerized device 30 via a network 40. A communication protocol may be established by which the computerized device 30 and the database 50 may exchange data.

Referring now to the block diagram of FIG. 3, the flow of data among the components of the system 10 will now be discussed. An interface 20 may be provided to a user, which he or she may manipulate or interact with. The user may define search parameters and commence a search using the interface 20. Search parameters may include search terms and a category of results. Search terms may include one or more word, which may be entered as a text string that can be compared to data 54 in a database 50. The category of results may provide instructions to the search engine 22 as to the purpose of the search. More specifically, without limitation, the category of results may allow users to affect the data 54 searched in the database 50 and the results returned to the user from the search.

Categories may include physician, location, procedure or diagnosis, facility, specialty, physical symptoms, and other additional categories. The physician category may include information relating to a physician's identification, such as first and/or last name. The location category may include information relating to a location at which a physician can be found, such as a geographical location by street address, city, state, ZIP code, and/or other location information. The procedure or diagnosis category may include related procedure, diagnosis, and other operation and may be stated in medical phrases and/or common vernacular. The facility category may include information relating to the hospital, treatment center, office, or other facility at which the physician practices. The specialty category may include information relating to specific areas of practice and/or medical conditions in which a physician practices. The physical symptoms category may include information relating to symptoms experienced by a user or analyzed by a physician. Skilled artisans will appreciate additional categories by which information may be associated in a database 50.

The search engine 22 may receive the search parameters provided by the user and commence a search for results. As will be discussed in greater detail below, the search engine 22 may analyze the search parameters to perform the search. The search engine 22 may operate in combination with the database 50 to locate relevant data 54 stored in the database 50.

The database 50 may include data 54 relating to one or more physician. The database 50 may also include a database engine 52, which may analyze the data 54 within the database 50 for compliance with the search parameters received by the search engine 22. Optionally, multiple databases 50 may be operatively connected to the search engine 22 via a physical or networked connection.

In operation, the system 10 may combine multiple dimensions of search terms, data types, existing and historical records to dynamically create search results with a significant degree of accuracy. Historical records may include a number of times a doctor has performed a certain procedure, length of time practicing in a field, duration of career at a particular facility, and other medical and/or practice related information. The system 10 uses sophisticated calculation methods to analyze search parameters to efficiently search a database 50 and return results with a high degree of accuracy.

An illustrative method for operating the system of the present invention is provided below in the interest of clarity. Those of skill in the art will appreciate obvious variants of one or more of the illustrative steps, which is intended to be included as part of the scope of this disclosure. While the below illustrative operation clearly discloses a method of operation for the present intention, it is not intended to limit the scope of the invention in any way. Numerical references to elements of the invention are reflective of their illustration in FIGS. 1-3.

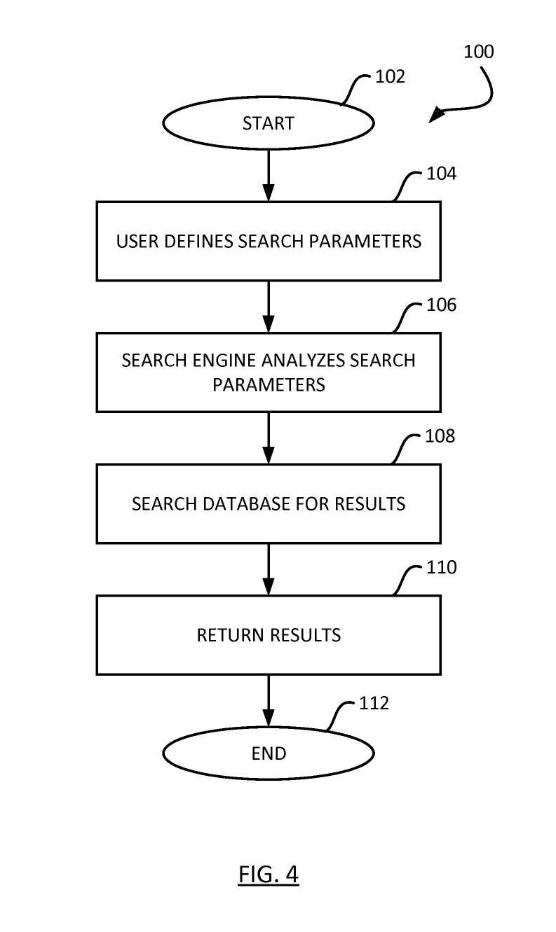

Referring now to flowchart 100 of FIG. 4, an illustrative method for accurately searching information in a database 50 will now be discussed. Starting at Block 102, the method may begin with a user defining search parameters. (Block 104). The user may define his or her search parameters, for example, using the interface 20. The search engine 22 may then analyze the search parameters. (Block 106). Once the search parameters have been analyzed, the system 10 may search the database 50 for results. (Block 108). Those of skill in the art will appreciate that the system 10 may optionally search multiple databases 50, sequentially and/or simultaneously. Once the database(s) 50 have been searched, the system 10 may return results to the user. (Block 110). The results may be received by the user via the interface 20. After the results have been returned to the user, the operation may terminate at Block 112.

Referring now to flowchart 120 of FIG. 5, the operation of defining search parameters, which has been provided by Block 104 of FIG. 4, will now be discussed in greater detail. Viewing flowchart 120, starting at Block 122, the method may begin upon a user accessing the interface 20. (Block 124). The user may access the interface using a dedicated software program, a web-based interface, such as a website, or other interface. The user may then enter one or more search term using the interface 20. (Block 126). The search term may include virtually any piece of information that he or she believes to return a relevant result. The user may also select a category of results. (Block 128). As discussed above, the category of results may relate to the purpose of the search and the desired results to be returned. Once the user has defined the parameters of the search, the user may then commence the search. (Block 130). After the search has commenced, the operation of flowchart 120 may terminate at Block 132.

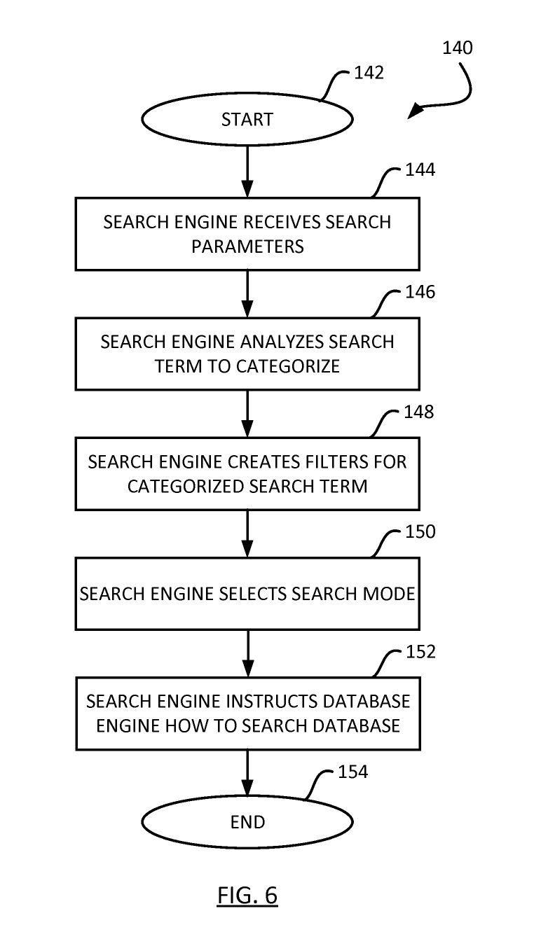

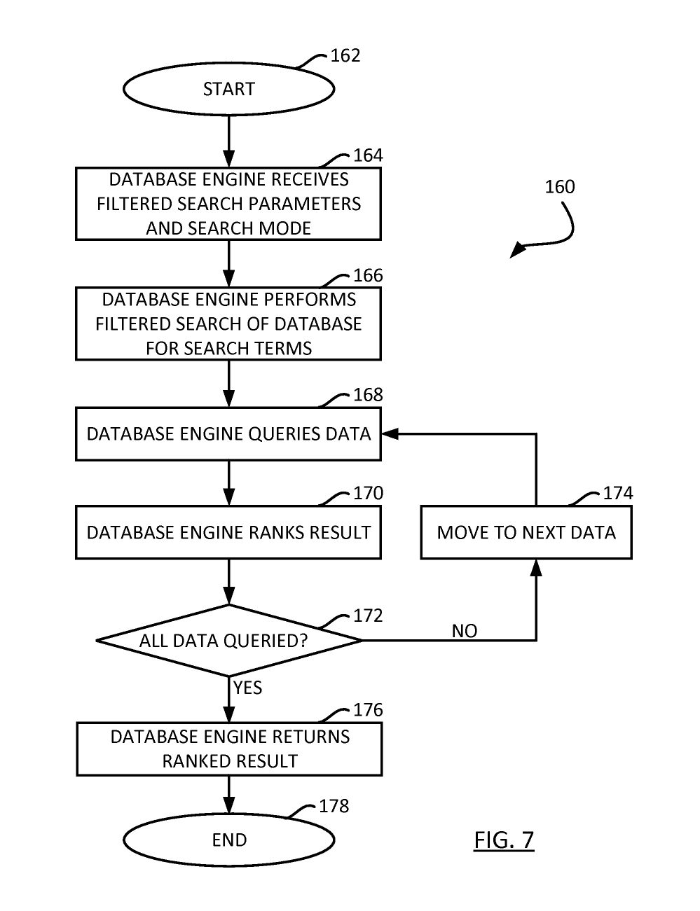

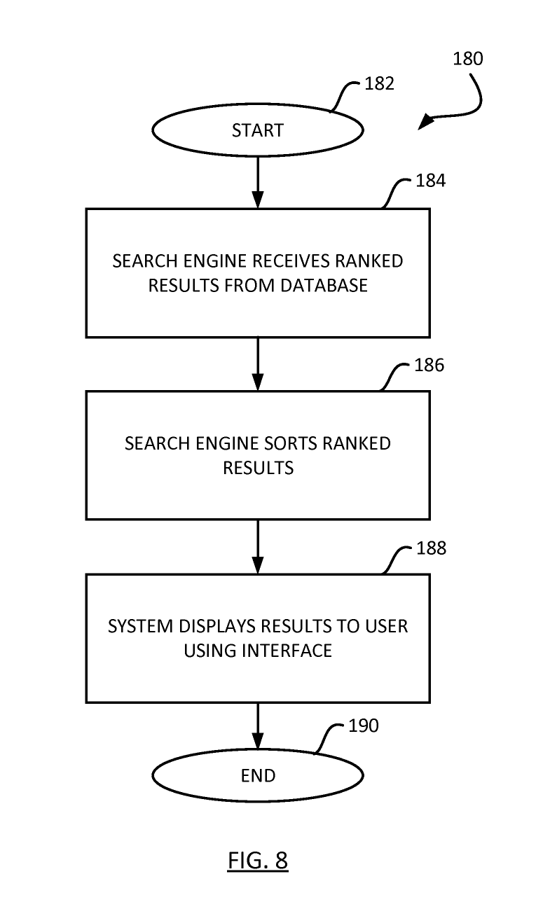

Referring now to flowchart 140 of FIG. 6, the operation of analyzing the search parameters, which has been provided by Block 104 of FIG. 4, will now be discussed in greater detail. Viewing flowchart 140, starting at Block 142, the method may begin as the search engine 22 receives the search parameters provided by the user via the interface 20. (Block 144). The search parameters may be transmitted by the computerized device 30 on which the interface 20 is operated to the search engine 22, for example, over a network 40. The search engine 22 may then analyze the search term, which may be categorized for the search. (Block 146). Categorization of the term for the search may enable the term to be searched in one or more categories that may produce a result in the category of result. The search category may, and often will, differ from the category of the result. For example, a search for a physician (category of result selected as physician) may categorize the search terms to be searched through the database 50 for data 54 relating to symptom, location, procedure or diagnosis, facility, and/or specialty to produce results. In another example, terms for a search for location results may be searched through the database 50 using data 54 relating to physician, symptoms, procedure or diagnosis, facility, and/or specialty to produce the results.

To reduce the number of irrelevant or undesired results, the search engine 22 may create one or more filter to narrow the scope of the search. (Block 148). Filters may be created respective to the categorization of the search terms performed at Block 146. The search engine 22 may additionally select a search mode to be applied to the search. (Block 150). A search mode may instruct the database engine 52 on how to look for the values of the search terms which may be passed to it by the search engine 22. The search mode may also instruct the database engine 52 how to query the database 50. The search engine 22 may then instruct the database engine 52 how to search the database 50. (Block 152). The operation of flowchart 140 may then terminate at Block 154.

As a specific example to the operation illustrated in flowchart 140, a user may provide search terms of “chest pain” and selected to return results in the category of physicians. The system 10 may categorize the search terms as symptoms. The search engine 22 would filter the scope of the search and define the search mode to query the database 50 only relating to symptoms. Results of physicians may then be provided to the user that are associated with data 54 of the symptoms-based search terms defined via the interface 20.

Referring now to flowchart 160 of FIG. 7, the operation of searching a database 50, which has been provided by Block 108 of FIG. 4, will now be discussed in greater detail. Viewing flowchart 160, starting at Block 162, the method may begin upon the database engine 52 receiving filtered search parameters and search mode from the search engine 22. (Block 164). The database engine 52 may then perform a filtered search of the data 54 included in the database 50 for the search terms. (Block 166). To perform the search, the database engine 52 may query an entry in the database 50 matching the filtered search parameters. (Block 168).

The result determined as the database engine 52 searches the database 50 may be ranked. (Block 170). Ranking may include applying various tiers of relevance of the result to the search term. For example, the results may be ranked as YES, MAYBE, or NO. A ranking of YES may be applied to results having a high degree of correlation. A ranking of MAYBE may be applied to results having a medium degree of correlation. A ranking of NO may apply to results having a low degree of correlation. Skilled artisans will appreciate additional ranking mechanisms, which may include more or less tiers than the above example.

The database engine 52 may then determine whether all data entries 54 within the filtered parameters of the database 50 have been queried. (Block 172). If data entries 54 remain, the database engine 52 may move to the next data entry 54 at Block 174, after which it will return to the operation of Block 168 and query the new data entry 54. If no data entries 54 remain, the database engine 52 may return the ranked results (Block 176). The operation of flowchart 160 may then terminate at Block 178.

Referring now to flowchart 180 of FIG. 8, the operation of returning results, which has been provided by Block 110 of FIG. 4, will now be discussed in greater detail. Viewing flowchart 180, starting at Block 182, the method may begin upon the search engine 22 receiving the ranked results from the database 50. (Block 184). The search engine 22 may then sort the results according to relevance and ranking (Block 186). For example, without limitation, the search engine 22 may include all results ranked as YES in the results displayed to the user. Also, the search engine 22 may include results ranked as MAYBE at a lower position on the list of results provided to the user. Alternatively, the search engine 22 may provide the user with an option to perform additional searching of results marked MAYBE. Results ranked NO may be excluded in the list provided to the user.

After the results have been ranked, the system 10 may provide a list of results to the user. (Block 188). The results may be viewed by the user via the interface 20, which may be accessible over the network 40. In an embodiment, the results may be displayed to the user approximately as they are determined by the system. For example, as the database engine 52 analyzes the data 54 in the database 50, it may update the results displayed to the user approximately in real time. Alternatively, the results may be provided to the user in their entirety upon completion of the search. The operation may then terminate at Block 190.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An information retrieval system comprising:
an interface operable on a computerized device with a processor and memory to be manipulated by a user to receive a search term;
a search engine to analyze the search terms to create a filter and select a search mode;
a database engine to perform a filtered search of a database using the search terms created by the search engine and return results that are ranked;
wherein the search engine sorts the results that are ranked to be displayed to the user.

2. The system of claim 1, wherein the interface is further manipulated by the user to select a category of results, ranking of the results being affected by the category of results selected.

3. The system of claim 2, wherein the category of results is selected from a group consisting of physicians, procedure or diagnosis, symptoms, location, facilities, and specialties.

4. The system of claim 1, wherein the results are ranked by the database engine prior to being returned to the search engine.

5. The system of claim 1, wherein the results are displayed to the user via the interface.

6. The system of claim 1, wherein the results are displayed to the user approximately as the results are determined.

7. The system of claim 1, wherein the interface is presented to the user over a network.

8. The system of claim 1 wherein the interface is presented to the user via a website.

9. A method for retrieving information using an information retrieval system with a processor and memory comprising:
(a) defining a search parameter using an interface;
(b) analyzing the search parameter using a search engine to create a filter and select a search mode;
(c) searching a database using a database engine with the search parameter filtered by the search engine to return results;
(d) ranking the results;
(e) sorting the results that are ranked to be displayed to a user via the interface.

10. The method of claim 9, wherein the search parameter comprises a search term and a category of results, and wherein step (d) further comprises ranking the results respective to the category of results selected.

11. The method of claim 10, wherein the category of results is selected from a group consisting of physicians, procedure or diagnosis, symptoms, location, facilities, and specialties.

12. The method of claim 9, wherein step (d) is performed using the database engine.

13. The method of claim 9, wherein step (e) is performed using the search engine.

14. The method of claim 9, wherein the interface is presented to the user over a network.

15. The method of claim 9, wherein the interface is presented to the user via a website.

16. The method of claim 9, wherein the step (e) further comprises displaying the results to the user approximately as the results are determined.

17. A method for retrieving information using an information retrieval system comprising a processor and memory, the method comprising:
(a) defining a search term using an interface accessible over a network;
(b) analyzing the search term using a search engine to create a filter and select a search mode;
(c) searching a database using a database engine with the search term filtered by the search engine to return results;
(d) ranking the results using the database engine;
(e) sorting the results that are ranked using the search engine to be displayed to a user via the interface.

18. The method of claim 17, wherein step (a) further comprises selecting a category of results and wherein step (d) further comprises ranking the results respective to the category of results selected.

19. The method of claim 18, wherein the category of results is selected from a group consisting of physicians, procedure or diagnosis, symptoms, location, facilities, and specialties.

20. The method of claim 17, wherein step (d) further comprises displaying the results to the user approximately as the results are determined.
